(19) United States
(12) Patent Application Publication
(10) Pub. No.: US 2021/0226869 A1
(43) Pub. Date: Jul. 22, 2021

(54) OFFLINE CONNECTIVITY CHECKS

(71) Applicant: VMware, Inc., Palo Alto, CA (US)

(72) Inventors: Sharath BHAT, San Jose, CA (US); Yashika NARANG, Sunnyvale, CA (US); Xinghua HU, San Jose, CA (US); Xinhua HONG, Campbell, CA (US); Vinay JAIN, San Jose, CA (US); Neeraj DIXIT, Sunnyvale, CA (US)

(73) Assignee: VMware, Inc., Palo Alto, CA (US)

(21) Appl. No.: 16/748,764

(22) Filed: Jan. 21, 2020

(51) Int. Cl. H04L 12/26; H04L 12/733; H04L 12/713; H04L 29/12

(52) U.S. Cl. CPC H04L 43/0811; H04L 43/0817; H04L 61/6022; H04L 45/586; H04L 45/20

(57) ABSTRACT

One example may comprise a computer system receiving a request to perform an offline connectivity check between a source endpoint and a destination endpoint; and obtaining logical network information associated with a production environment in which multiple logical network elements are deployed. Based on the logical network information, the computer system may identify a logical network path connecting the source endpoint and the destination endpoint and perform an offline traversal of the logical network path outside of the production environment. In response to detecting a connectivity issue during the offline traversal, report information identifying the logical network path and the connectivity issue may be generated.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each virtual machine is generally provisioned with virtual resources to run an operating system and applications. The virtual resources may include central processing unit (CPU) resources, memory resources, storage resources, network resources, etc. In practice, various network issues might affect the performance of VMs in the SDN environment, in which case it is desirable to perform network troubleshooting and diagnosis to identify those issues.

### BRIEF DESCRIPTION OF DRAWINGS

FIG. 1 is a schematic diagram illustrating an example software-defined networking (SDN) environment in which offline connectivity check may be performed;

FIG. 2 is a schematic diagram illustrating an example computer system for offline connectivity check in an SDN environment;

FIG. 3 is a flowchart of an example process for a computer system to perform offline connectivity check in an SDN environment;

FIG. 4 is a schematic diagram illustrating an example detailed process for a computer system to perform offline connectivity check in an SDN environment;

FIG. 5 is a schematic diagram illustrating example logical network information to facilitate offline connectivity check;

FIG. 6 is a schematic diagram illustrating an example offline connectivity check for north-south traffic; and

FIG. 7 is a schematic diagram illustrating an example offline connectivity check for east-west traffic.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. For example, a first element may be referred to as a second element, and vice versa.

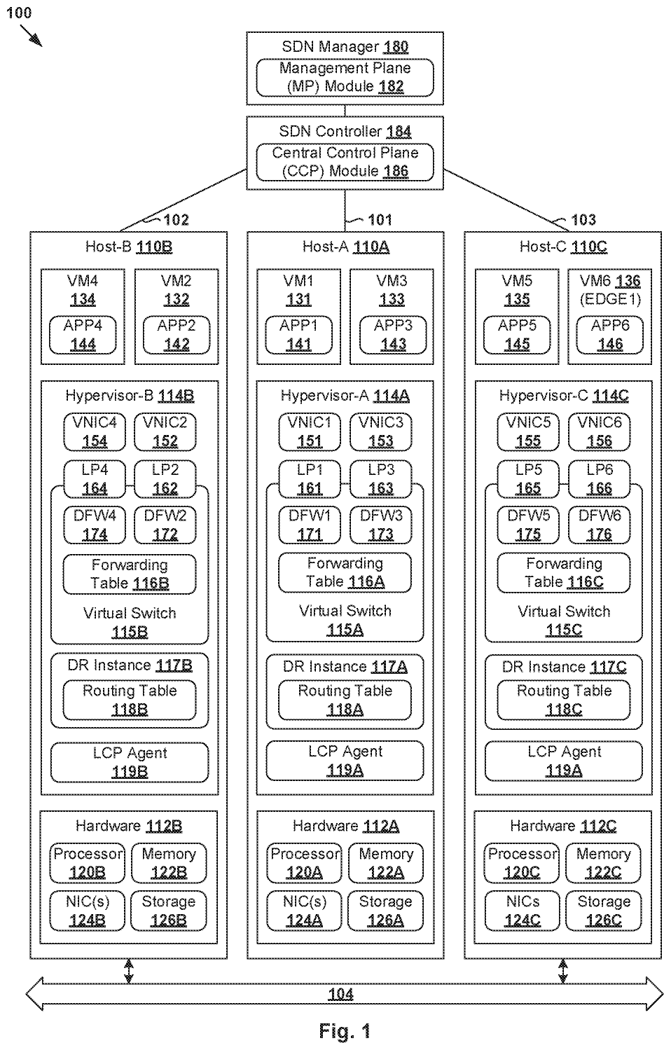

Challenges relating to network troubleshooting and diagnosis will now be explained in more detail using FIG. 1, which is a schematic diagram illustrating example software-defined networking (SDN) environment 100 in which offline connectivity check may be performed. Depending on the desired implementation, SDN environment 100 may include additional and/or alternative components than that shown in FIG. 1. SDN environment 100 includes multiple hosts 110A-C that are inter-connected via physical network 104. In practice, SDN environment 100 may include any number of hosts (also known as a “host computers”, “host devices”, “physical servers”, “server systems”, “transport nodes,” etc.), where each host may be supporting tens or hundreds of virtual machines (VMs).

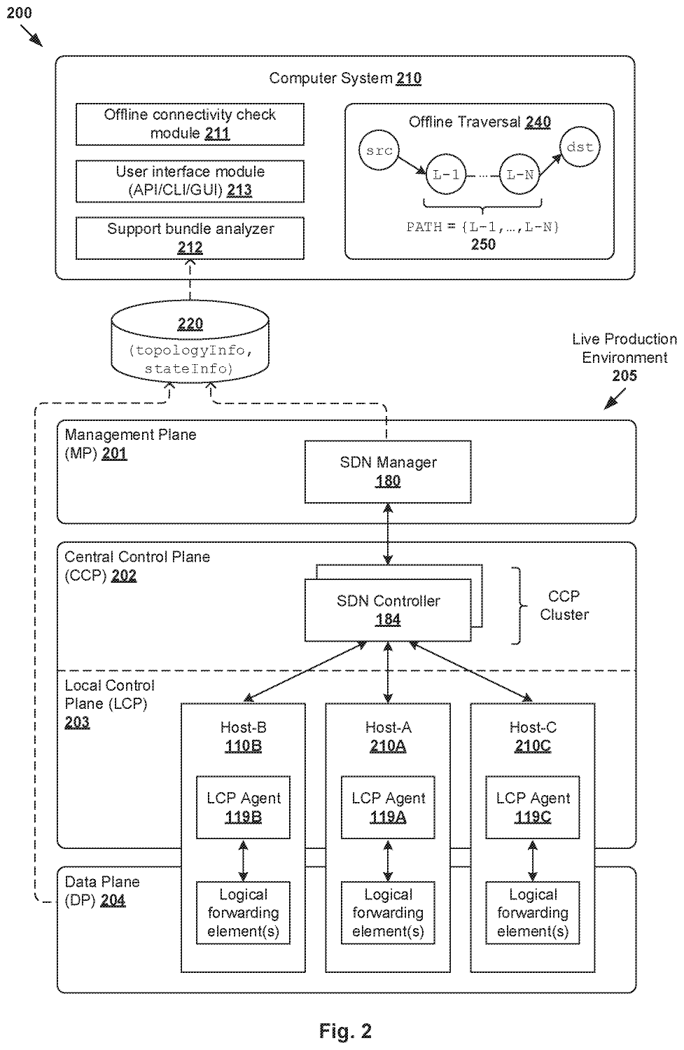

Each host 110A/110B/110C may include suitable hardware 112A/112B/112C and virtualization software (e.g., hypervisor-A 114A, hypervisor-B 114B, hypervisor-C 114C) to support various VMs. For example, hosts 110A-C may support respective VMs 131-136 (see also FIG. 2). Hypervisor 114A/114B/114C maintains a mapping between underlying hardware 112A/112B/112C and virtual resources allocated to respective VMs. Hardware 112A/112B/112C includes suitable physical components, such as central processing unit(s) (CPU(s)) or processor(s) 120A/120B/120C; memory 122A/122B/122C; physical network interface controllers (NICs) 124A/124B/124C; and storage disk(s) 126A/126B/126C, etc.

Virtual resources are allocated to respective VMs 131-136 to support a guest operating system (OS) and application(s). For example, VMs 131-136 support respective applications 141-146 (see “APP1” to “APP6”). The virtual resources may include virtual CPU, guest physical memory, virtual disk, virtual network interface controller (VNIC), etc. Hardware resources may be emulated using virtual machine monitors (VMMs). For example in FIG. 1, VNICs 151-156 are virtual network adapters for VMs 131-136, respectively, and are emulated by corresponding VMMs (not shown for simplicity) instantiated by their respective hypervisor at respective host-A 110A, host-B 110B and host-C 110C. The VMMs may be considered as part of respective VMs, or alternatively, separated from the VMs. One VM may be associated with multiple VNICs (each VNIC having its own network address).

Although examples of the present disclosure refer to VMs, a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B/114C implements virtual switch 115A/115B/115C and logical distributed router (DR) instance 117A/117B/117C to handle egress packets from, and ingress packets to, corresponding VMs. Through virtualization of networking services in SDN environment 100, logical networks (also referred to as “overlay networks,” “logical overlay networks” or “software-based virtual networks”) may be provisioned, changed, stored, deleted and restored programmatically without having to reconfigure the underlying physical hardware architecture. Various networking services may be implemented in software, such as switching, routing, access control, firewalling, etc. A logical network may be formed using any suitable tunneling protocol, such as Virtual eXtensible Local Area Network (VXLAN), Generic Network Virtualization Encapsulation (Geneve), etc.

In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-C and represented internally using forwarding tables 116A-C at respective virtual switches 115A-C. Forwarding tables 116A-C may each include entries that collectively implement the respective logical switches. Further, logical DRs that provide logical layer-3 connectivity may be implemented collectively by DR instances 117A-C and represented internally using routing tables 118A-C at respective DR instances 117A-C. Routing tables 118A-C may each include entries that collectively implement the respective logical DRs.

Packets may be received from, or sent to, each VM via an associated logical port. For example, logical switch ports 161-166 (see “LP1” to “LP6”) are associated with respective VMs 131-136. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-C in FIG. 1, whereas a “virtual switch” may refer generally to a software switch or software implementation of a physical switch. In practice, there is usually a one-to-one mapping between a logical port on a logical switch and a virtual port on virtual switch 115A/115B/115C. However, the mapping may change in some scenarios, such as when the logical port is mapped to a different virtual port on a different virtual switch after migration of a corresponding virtualized computing instance (e.g., when the source host and destination host do not have a distributed virtual switch spanning them).

To protect VMs 131-136 against security threats caused by unwanted packets, hypervisors 114A-C may implement firewall engines to filter packets. For example, distributed firewall (DFW) engines 171-176 (see “DFW1” to “DFW6”) are configured to filter packets to, and from, respective VMs 131-136 according to firewall rules. In practice, network packets may be filtered according to firewall rules at any point along a datapath from a VM to corresponding physical NIC 124A/124B/124C. In one embodiment, a filter component (not shown) is incorporated into each VNIC 151-156 that enforces firewall rules that are associated with the endpoint corresponding to that VNIC and maintained by respective DFW engines 171-176.

SDN manager 180 and SDN controller 184 are example network management entities in SDN environment 100. One example of an SDN controller is the NSX controller component of VMware NSX® (available from VMware, Inc.) that operates on a central control plane. SDN controller 184 may be a member of a controller cluster (not shown for simplicity) that is configurable using SDN manager 180 operating on a management plane (MP). Network management entity 180/184 may be implemented using physical machine(s), VM(s), or both. Logical switches, logical routers, and logical overlay networks may be configured using SDN controller 184, SDN manager 180, etc. To send or receive control information, a local control plane (LCP) agent (not shown) on host 110A/110B/110C may interact with central control plane (CCP) module 186 at SDN controller 184 via control-plane channel 101/102/103.

Hosts 110A-C may also maintain data-plane connectivity among themselves via physical network 104 to facilitate communication among VMs located on the same logical overlay network. Hypervisor 114A/114B/114C may implement a virtual tunnel endpoint (VTEP) (not shown) to encapsulate and decapsulate packets with an outer header (also known as a tunnel header) identifying the relevant logical overlay network (e.g., using a “virtual” network identifier (VNI) added to a header field). For example in FIG. 1, hypervisor-A 114A implements a first VTEP associated with (IP address=IP-A, MAC address=MAC-A, VTEP label=VTEP-A), hypervisor-B 114B implements a second VTEP with (IP-B, MAC-B, VTEP-B), hypervisor-C 114C implements a third VTEP with (IP-C, MAC-C, VTEP-C), etc. Encapsulated packets may be sent via an end-to-end, bi-directional communication path (known as a tunnel) between a pair of VTEPs over physical network 104.

In practice, traffic among of VMs 131-136 may be affected by various network issues. However, users may find debugging difficult and cumbersome because of the complexity of SDN environment 100. For example, through networking virtualization, logical networks and logical elements (e.g., logical switches and logical routers) are generally realized over multiple physical hosts 110A-C. Given the complex architecture, debugging traffic outages might be tedious, especially when there is minimal or no access to the live system. It is also challenging for any debugger to traverse paths connecting the logical elements across different hosts to identify the point of failure.

Conventionally, one tool for network troubleshooting and diagnosis involves injecting a probe packet in SDN environment 100. For example, to debug connectivity issues between VM1 131 and VM6 136, a probe packet may be injected at source logical port=LP1 161 connected to VM1 131. The probe packet is then forwarded over physical network 104 towards VM6 136. To be able to inject probe packets, it is essential for a debugger (e.g., engineer) to have access to a live production environment of SDN environment 100. In cases where there is little or no access to the live setup, debugging is challenging or simply cannot be performed. Even when there is access, there might be a waiting time.

### Offline Connectivity Checks

According to examples of the present disclosure, an offline approach may be implemented to perform connectivity checks for network troubleshooting and diagnosis purposes. Unlike conventional approaches, it is not necessary for debuggers to have access to a live setup of SDN environment 100 in order to inject probe packets. In contrast, an offline path of a logical network path may be performed to identify any connectivity issues. As SDN environment 100 increases in scale and complexity, any improvement in network troubleshooting and diagnosis may lead to reduced system downtime and better performance.

Some examples will be explained using FIG. 2, which is a schematic diagram illustrating example architecture 200 for offline connectivity check in SDN environment 100 in FIG. 1. Depending on the desired implementation, example architecture 200 may include additional and/or alternative components than that shown in FIG. 2. Example architecture 200 may include computer system 210 capable of interacting with live production environment 205 that includes SDN manager 180 (see MP 201), SDN controller 184 (see CCP 202) and hosts 110A-C on local control plane (see LCP 203) and data plane (see DP 204).

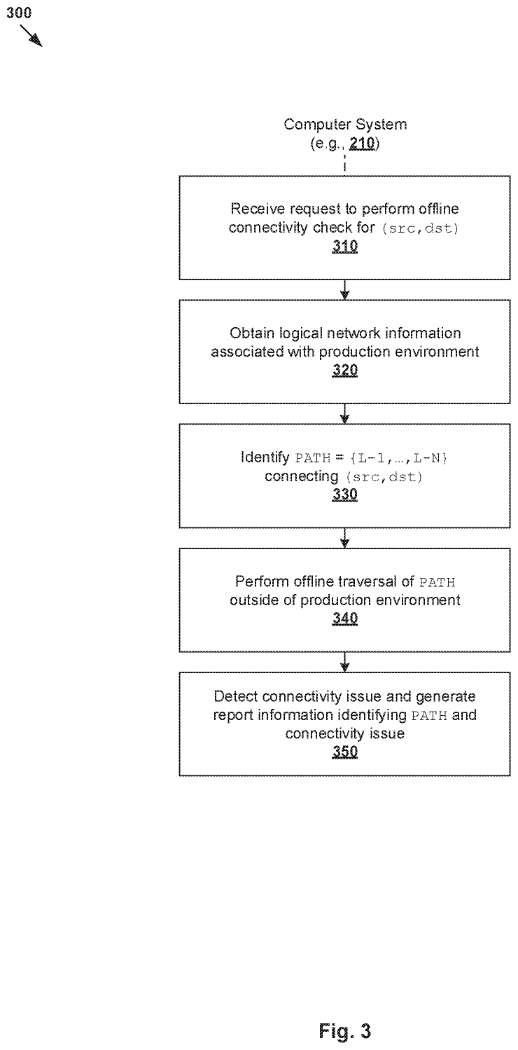

Computer system 210 may support various modules 211-213 to perform an offline traversal (see 240) of a logical network path (see 250) outside of production environment 205. In more detail, FIG. 3 is a flowchart of example process 300 for a computer system to perform offline connectivity check in SDN environment 100. Example process 300 may include one or more operations, functions, or actions illustrated by one or more blocks, such as 310 to 350. The various blocks may be combined into fewer blocks, divided into additional blocks, and/or eliminated depending on the desired implementation. In practice, computer system 210 may be implemented using virtual and/or physical entities. The term “endpoint” may refer generally an originating node (“first endpoint” or “source endpoint”) or terminating node (“second endpoint” or “destination endpoint”) of a packet flow.

At 310 in FIG. 3, computer system 210 may receive a request to perform an offline connectivity check between a source endpoint (e.g., VM1 131) and a destination endpoint (e.g., VM6 136). At 320, logical network information associated with a production environment in which multiple logical network elements are deployed may be obtained. At 330, based on the logical network information, a logical network path (PATH) connecting the source endpoint and the destination endpoint may be identified. At 340, based on the logical network information, an offline traversal (see 240 in FIG. 2) of PATH may be performed outside of the production environment. At 350, in response to detecting a connectivity issue during the offline traversal, report information identifying PATH and the connectivity issue may be generated.

As used herein, the term “production environment” may refer generally to an environment in which software products are put into operation to perform their intended functions and made available for users. The term “offline traversal” may refer generally to an analysis that is performed outside of the production environment to mimic how packets are forwarded along a path within the production environment. The “connectivity issue” may be caused by various reasons, such hardware failure, software failure, network failure, network congestion, firewall rule, invalid service path, SVM failure, invalid logical or physical network configuration, a combination thereof, etc.

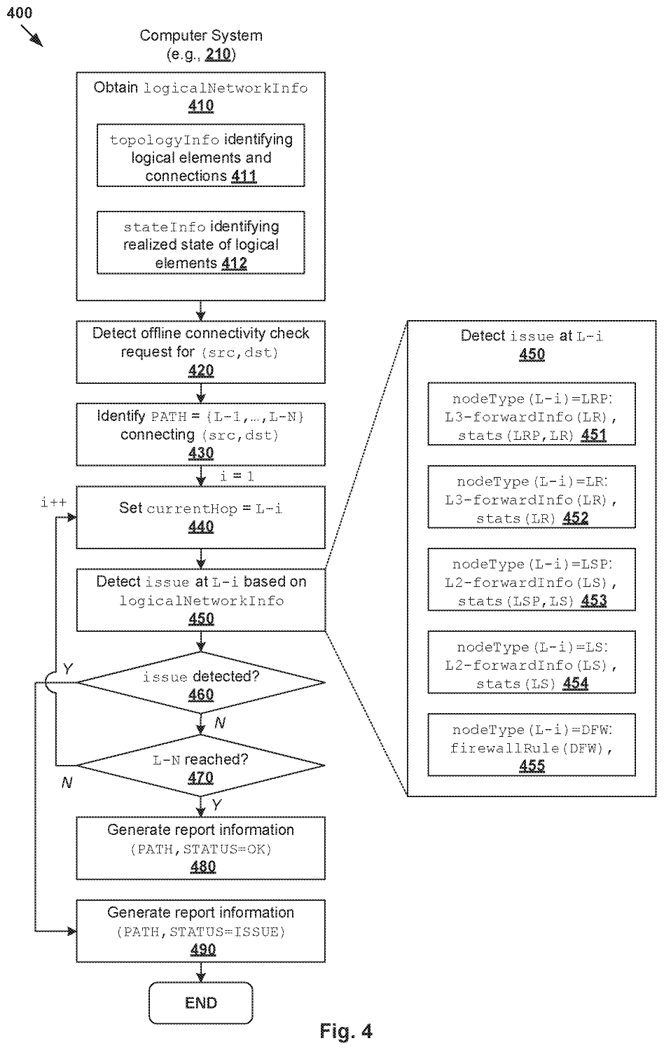

The term “logical network element” may refer generally to a logical entity connecting a pair of endpoints (e.g., VM1 131 and VM6 136), such as a logical switch port (LSP), logical switch (LS), logical router port (LRP), logical DR, logical SR, edge node, VNIC, etc. As will be described using FIG. 4, the offline traversal may involve assessing reachability between a pair of current-hop logical network element and a next-hop logical network element located on the logical network path. The logical network information may include topology information identifying connections among multiple logical network elements and state information associated with the multiple logical network elements.

### Logical Network Information

FIG. 4 is a flowchart of example detailed process 400 for a computer system to perform offline connectivity check in SDN environment 100. Example process 400 may include one or more operations, functions, or actions illustrated by one or more blocks, such as 410 to 490. The various blocks may be combined into fewer blocks, divided into additional blocks, and/or eliminated depending on the desired implementation.

At 410 in FIG. 4, computer system 210 may obtain logical network information (also called “support bundles”) associated with various logical network elements in SDN environment 100, such as topology information (see 411) and state information (see 412). Topology information 411 may be processed to identify the logical network elements and connections among them. State information 412 associated with the logical network elements may include layer-2 and/or layer-3 forwarding information, tunnel information, statistics captured at the logical network elements, etc. As shown in FIG. 2, logical network information may be obtained from production environment 205 (e.g., periodically) and stored in datastore 220 for subsequent analysis.

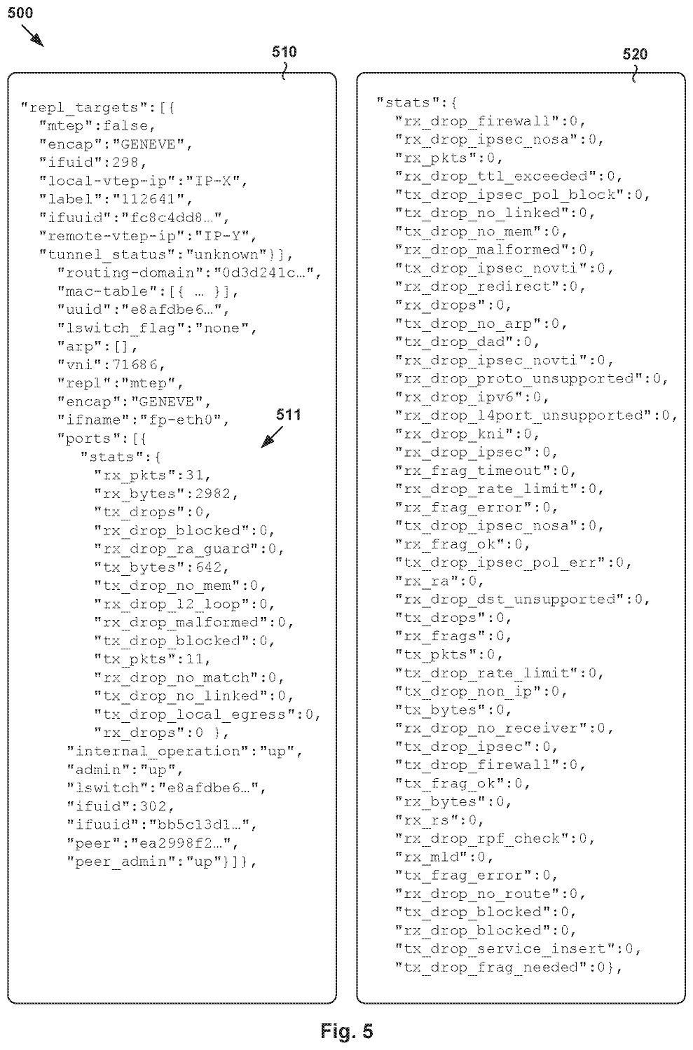

FIG. 5 is a schematic diagram illustrating example logical network information 500 to facilitate offline connectivity check in SDN environment 100. In relation to a logical switch (see 510), associated state information associated may include universally unique identifiers (UUIDs), VTEP information (e.g., VTEP IP address, label and protocol), layer-2 forwarding information (MAC table entries), logical switch port statistics, peer information, address resolution protocol (ARP) table, interface information, or any combination thereof, etc.

For a logical switch port (see 511), associated statistics may include receive (RX) and/or transmit (TX) information, such as number of packets (rx/tx_pkts), bytes (rx/tx_bytes) and dropped packets (rx/tx_drop). For packets that are dropped, the statistics may further indicate a network connectivity issue, such as no memory (drop_no_mem), layer-2 loop error (drop_l2_loop), malformed packets (drop_malformed), blocked (drop_blocked), no matching route entry (drop_no_match), the outgoing port has no linked peer port (drop_no_linked), IP version 6 (IPv6) route advertisement (RA) packet dropped (drop_ra_guard), etc.

In relation to a logical router (see 520), associated state information may also include UUlDs, layer-3 forwarding information identifying routes reachable from the logical router, ARP table, logical router port statistics, interface information, or any combination thereof, etc. Example statistics collected at a logical router port may include RX and/or TX information, such as number of packets (rx/tx_pkts), bytes (rx/tx_bytes) and dropped packets (rx/tx_drop). Additional drop reasons may include firewall rule (drop_firewall), time-to-live exceeded (drop_ttl_exceeded), malformed packets (drop_malformed), security-related issue (drop_ipsec), protocol-related issue (drop_proto_unsupported, drop_l4port_unsupported), no entry in ARP table (drop_no_arp), fragmentation error (frag_error, drop_frag_needed), service insertion issue (drop_service_insert), etc. Any additional and/or alternative statistics may be collected for subsequent analysis below.

### Offline Connectivity Checks for North-South Traffic

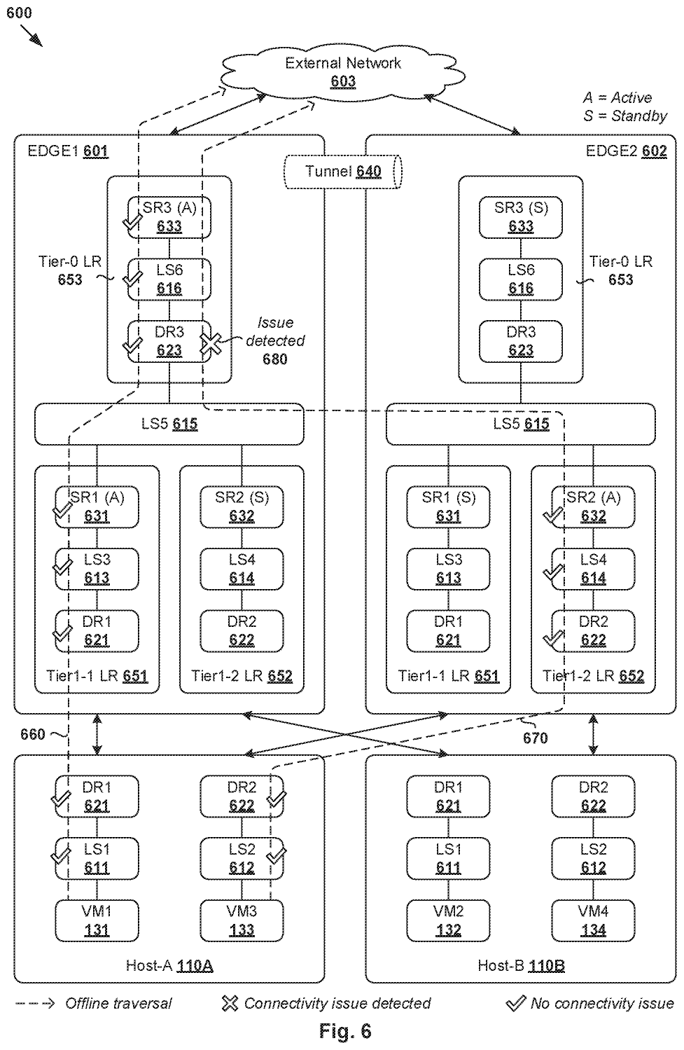

Blocks 420-490 in FIG. 4 will be explained using FIG. 6, which is a schematic diagram illustrating example offline connectivity check 600 for north-south traffic.

### (a) Logical Network Path

At 420 in FIG. 4, computer system 210 may receive a user's request to perform an offline connectivity check between source=VM1 131 and a destination (e.g., IP address=5.5.5.1) on external network 603. The request may be received from a user device (e.g., operated by a network administrator) via any suitable interface 213 supported by computer system 210, such as graphical user interface (GUI), command-line interface (CLI), application programming interface (API) calls, etc. In one example, the user's request may be an offline path command supported by module 213.

At 430 in FIG. 4, based on logical network information obtained at block 410, computer system 210 may identify a logical network path connecting source VM1 131 and the external destination. Here, the path may be denoted as PATH={L-1, . . . ,L-N}, where L-i denotes the i^{th} logical network element of a set of N logical elements. Each logical network element may be used as an observation point at which associated state information may be analyzed to identify any connectivity issue.

In the example in FIG. 6, there are two EDGE nodes 601-602 that are connected to hypervisors 114A-B on respective hosts 110A-B. Using a two-tier topology, an upper tier (tier-0) is associated with a data center provider and a lower tier (tier-1) with a tenant. EDGE 601/602 further supports one provider logical router (tier-0) and two tenant logical routers (e.g., tier1-1 and tier1-2). Each LR may include at least one distributed router (DR) and at least one service router (SR). For example, tier-1 LR 651/652 may include DR 621/622 and SR 631/632 that are connected via transit LS 613/614. Tier-0 LR 653 supported by EDGE 601/602 is connected with external network 603 towards the north, and tier-1 LRs 651-652 towards the south via LS5 615.

A DR is generally responsible for one-hop distributed routing between logical switches and/or logical routers. Each DR 621/622 may span multiple transport nodes. For example, VMs 131-132 are connected via LS1 611 to DR1 621, which spans EDGE nodes 601-602 and hosts 110A-B supporting VMs 131-132. Similarly, VMs 133-134 are each connected via LS2 611 to DR1 621, which spans EDGE nodes 601-602 and hosts 110A-B. An SR is responsible for delivering services in a centralized manner, such as firewall, load balancing, network address translation (NAT), intrusion detection, deep packet inspection, etc. In practice, EDGE 601/602 may be implemented using VM(s) or bare metal server(s). EDGE1 601 and EDGE2 602, which are connected via tunnel 640, provide multiple paths for hosts 110A-B to access external network 603.

A pair of SRs may be realized with high availability (HA) as active-standby cluster of services. EDGE1 601 and EDGE2 602 may belong to an edge cluster, each supporting an instance of tier-1 SR1 631, tier-1 SR2 632 and tier-0 SR3 633. Using an active-standby mode, only one instance of SR is active (“A”) or fully operational at one time, which another instance is on standby (“S”). For example, EDGE1 601 supports an active instance of tier-0 LR 653, and an active instance of tier1-1 LR 651. EDGE2 602 supports an active instance of tier1-2 LR 652. In the event of a failure of an active SR, the standby SR will take over the active role.

To identify PATH={L-1, . . . , L-N} between source VM1 131 and an external destination, computer system 210 may identify active instance=tier1-1 LR 651 on EDGE1 601, and active instance=tier-0 LR 653. In this case, PATH may include LS1 611, DR1 621, as well as active instance of tier1-1 LR 651, LS5 615 and active instance of tier-0 LR 653 on EDGE1 601. As observed here, a packet flow from VM1 131 to external network 603 might traverse along a path spanning multiple transport nodes. Using examples of the present disclosure, logical network information associated with PATH={L-1, . . . , L-N} may be analyzed in an offline manner. This way, it is not necessary to have access to the live system to perform a deep inspection of the logical network topology and all transport nodes involved.

### (c) Offline Traversal

At 440-470 in FIG. 4, PATH={L-1, . . . , L-N} may be traversed in an offline manner in that no actual packet is injected in the live system for connectivity check. In particular, starting with currentHop=L-1 (“current-hop logical network element”), logical network information associated with currentHop may be processed to assess reachability with next-hop L-2 (“next-hop logical network element”). The offline traversal process according to blocks 440-470 may be repeated until all logical network elements are considered, or a connectivity issue is detected. The logical network information captures the current state of logical constructs (i.e., logical network elements).

Block 450 may include identifying any connectivity issue based on the type of logical network elements located on PATH={L-1, . . . , L-N}. In the case of L-i=LR port (see 451), state information associated with an LR that owns the LR port may be inspected. Similarly, in the case of L-i=LR (see 452), state information associated with the LR may be inspected. The state information may include layer-3 forwarding information specifying routes reachable from the LR. A packet may be dropped because of a missing forwarding table entry or failed ARP resolution. For example, a connectivity issue may be detected when destination IP address=5.5.5.1 not found in a forwarding table of L-i, destination MAC address associated with IP address=5.5.5.1 not found in an ARP table of L-i, etc. Example packet-related statistics in FIG. 5 may also be inspected to identify any connectivity issues, such as a large number of packet drops at a port or interface of a logical switch or logical router.

In the case of L-i=logical switch port (see 453), state information associated with a logical switch owning the port may be inspected. Similarly, in the case of L-i=logical switch (see 454), state information associated with the logical switch may be inspected. The state information may include layer-2 forwarding information specifying MAC address(es) reachable from the logical switch. If no route is found, connectivity issue=destination is not reachable from VM1 131 is detected. Example statistics 510 in FIG. 5 may also be inspected to identify any issues, such as high number of dropped packets at a logical switch port.

Depending on desired implementation, PATH={L-1, . . . ,L-N} may include DFW engines (e.g., 171-174 in FIG. 1) at which firewall rules may be inspected to determine whether a packet will be allowed or blocked. In a further example, L-i may be a tunnel port of tunnel 640 for switching a packet may switch from one EDGE to another, such as to reach an active instance of an LR.

### (d) Report Information

At 480-490 in FIG. 4, report information may be generated based on the offline traversal. In one example, the report information may include at least a subset of logical network elements forming PATH={L-1, . . . , L-N} identified at block 430. The last L-i shown may indicate whether the connectivity issue is detected. In another example, the report information may further include state information associated with PATH={L-1, . . . ,L-N}, such as layer-3 forwarding table(s), layer-2 MAC table(s), ARP table(s), etc. Further, the report information may further include packet-related statistics associated with PATH={L-1, . . . ,L-N}. Various statistics explained using FIG. 5 are applicable here and will not be repeated for brevity.

In a first example in FIG. 6 (see 660), no connectivity issue is detected using during offline traversal of a logical network path between source=VM1 131 and a first destination on external network 603. In this case, the report information generated may be associated with the full path PATH=(LS1 611, DR1 621, active instance of tier1-1 LR 651, LS5 615, active tier-0 LR 653). Each L-1 may be assigned with a status relating to the offline traversal, such as RECEIVED, FORWARDED or DELIVERED. The report information may also include timestamp, transport node ID, drop reason, etc.

In a second example in FIG. 6 (see 670), a connectivity issue (see 680) is detected during offline traversal between source=VM3 133 and a second destination on external network 603. In this case, the report information may identify the following logical network elements: LS2 612, DR2 622, tier1-2 LR 652 with active SR2 632, LS5 615 and DR3 623 at which the connectivity issue is detected. Note that this example involves switching from EDGE2 602 to EDGE1 601 to access active instance of SR3 633 on EDGE1 601. In this case, support bundles of both EDGE nodes 601-602 will be inspected to identify any connectivity issue.

Any suitable connectivity issue 680 may be detected at DR3 623, such as when the MAC address of the second destination is unknown due to a failed ARP resolution. In this case, statistics associated with DR3 623 may be presented to the user (e.g., using CLI command) to provide finer-grain information of packet counter statistics. Alternatively or additionally, computer system 210 may raise an alarm in response to detecting that a particular packet counter (e.g., number dropped) exceeds a predetermined threshold. This way, computer system 210 may provide a unified view of SDN environment 100 to trace packet traversal paths in a live system.

### East-West Traffic

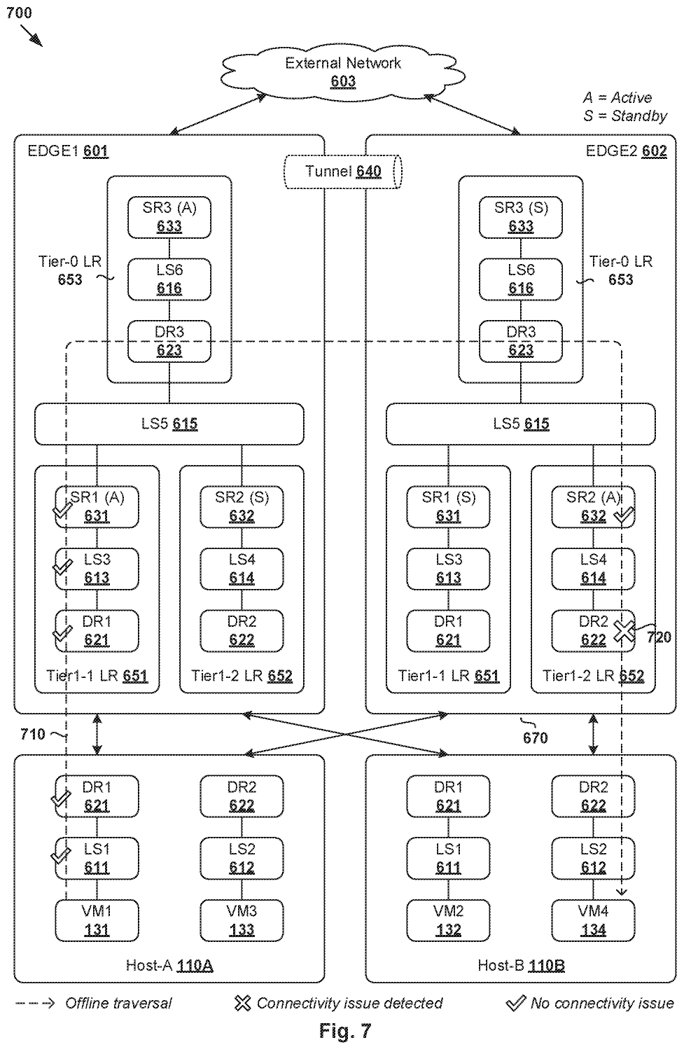

Example process 400 in FIG. 4 may be implemented for east-west traffic. Two examples are shown in FIG. 7, which is a schematic diagram illustrating example offline connectivity check 700 for east-west traffic. In this example, it is desirable to perform a connectivity check between source endpoint=VM1 131 on host-A 110A and destination endpoint=VM4 134 on host-B 110B. However, a debugger might have to little or no access to live production environment 205 in which these VMs operate. In this case, the debugger may access computer system 210 (or SDN manager 180) to initiate an offline check.

Based on logical network information obtained at block 430, a logical network path (see 710) between VM1 131 and VM3 133 may be identified. The logical network path (PATH) may include (LS1 611, DR1 621) on host-A 110A, (active tier1-1 LR 651, LS5 615, DR3 623) on EDGE1 601 as well as (LS5 615, active SR2 632, LS4 614, DR2 622) on EDGE2 602 and (DR2 622, LS2 612) on host-B 110B. For example, DR3 623 on EDGE1 601 may reach active SR2 632 on EDGE2 602 via a tunnel port associated with tunnel 640. Without accessing production environment 205, computer system 210 may perform an offline traversal of the logical network path based on associated state information.

For example, the reachability of destination=VM3 133 may be assessed at each “current hop” (L-i) included in PATH, starting at L-1 (e.g., source LS1 611 or DR1 621) until L-N (e.g., destination LS2 612 or DR2 622) is reached or a connectivity issue is detected. The reachability may be assessed based on layer-2 and/or layer-3 forwarding information, packet-related statistics, etc. In the example in FIG. 7, a connectivity issue (see 720) is detected at DR2 622 of tier1-2 LR 652. The connectivity issue may then be reported to the debugger to facilitate any suitable remediation action.

Given the complexity of networking virtualization architecture, debugging any packet drop is very time consuming and tedious task. Since examples of the present disclosure may be implemented offline, any dependency on the live setup of SDN environment 100 may be reduced, if not removed. The offline packet traversal tool may be implemented by computer system 210 to enhance visibility of packet flows, reduce debugging time and therefore improve efficiency. In practice, examples of the present disclosure may be extended to other networking scenarios, such as layer-2 virtual private network (L2VPN) and layer-3 VPN (L3VPN) configurations, etc.

### Container Implementation

Although explained using VMs 131-136, SDN environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 6, container technologies may be used to run various containers inside respective VMs 131-136. Containers are “OS-less”, meaning that they do not include any OS that could weigh 10 s of Gigabytes (GB). This makes containers more lightweight, portable, efficient and suitable for delivery into an isolated OS environment. Running containers inside a VM (i.e., “containers-on-VM”) not only leverages the benefits of container technologies but also that of virtualization technologies. The containers may be executed as isolated processes inside respective VMs.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 6. For example, a computer system capable of performing offline connectivity checks may be deployed in SDN environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method for a computer system to perform an offline connectivity check, wherein the method comprises:
receiving a request to perform an offline connectivity check between a source endpoint and a destination endpoint;
obtaining logical network information associated with a production environment in which multiple logical network elements are deployed;
based on the logical network information, identifying a logical network path connecting the source endpoint and the destination endpoint, wherein the logical network path includes at least a subset of the multiple logical network elements;
based on the logical network information, performing an offline traversal of the logical network path outside of the production environment; and
in response to detecting a connectivity issue during the offline traversal, generating report information identifying the logical network path and the connectivity issue.

2. The method of claim 1, wherein performing the offline traversal comprises:
assessing reachability of the destination endpoint from a current-hop logical network element located on the logical network path, wherein the logical network information includes layer-2 forwarding information or layer-3 forwarding information, or both.

3. The method of claim 2, wherein performing the offline traversal comprises:
in response to determination that the current-hop logical network element is a logical router port or a logical router, assessing the reachability based on layer-3 forwarding information associated with the logical router port or the logical router.

4. The method of claim 2, wherein performing the offline traversal comprises:
in response to determination that the current-hop logical network element is a logical switch port or a logical switch, assessing the reachability based on layer-2 forwarding information associated with the logical switch port or the logical switch.

5. The method of claim 1, wherein performing the offline traversal comprises:
assessing reachability of the destination endpoint from a current-hop logical network element located on the logical network path, wherein the logical network information includes packet-related statistics.

6. The method of claim 5, wherein generating the report information comprises:
generating the report information that includes packet-related statistics collected at the current-hop logical network element to indicate the connectivity issue.

7. The method of claim 1, wherein identifying the logical network path comprises:
based on the logical network information specifying an active-standby mode associated with a particular logical network element, selecting an active instance of the particular logical network element for the logical network path.

8. A non-transitory computer-readable storage medium that includes a set of instructions which, in response to execution by a processor of a computer system, cause the processor to perform a method of offline connectivity check, wherein the method comprises:
receiving a request to perform an offline connectivity check between a source endpoint and a destination endpoint;
obtaining logical network information associated with a production environment in which multiple logical network elements are deployed;
based on the logical network information, identifying a logical network path connecting the source endpoint and the destination endpoint, wherein the logical network path includes at least a subset of the multiple logical network elements;
based on the logical network information, performing an offline traversal of the logical network path outside of the production environment; and
in response to detecting a connectivity issue during the offline traversal, generating report information identifying the logical network path and the connectivity issue.

9. The non-transitory computer-readable storage medium of claim 8, wherein performing the offline traversal comprises:
assessing reachability of the destination endpoint from a current-hop logical network element located on the logical network path, wherein the logical network information includes layer-2 forwarding information or layer-3 forwarding information, or both.

10. The non-transitory computer-readable storage medium of claim 9, wherein performing the offline traversal comprises:
in response to determination that the current-hop logical network element is a logical router port or a logical router, assessing the reachability based on layer-3 forwarding information associated with the logical router port or the logical router.

11. The non-transitory computer-readable storage medium of claim 9, wherein performing the offline traversal comprises:
in response to determination that the current-hop logical network element is a logical switch port or a logical switch, assessing the reachability based on layer-2 forwarding information associated with the logical switch port or the logical switch.

12. The non-transitory computer-readable storage medium of claim 8, wherein performing the offline traversal comprises:
assessing reachability of the destination endpoint from a current-hop logical network element located on the logical network path, wherein the logical network information includes packet-related statistics.

13. The non-transitory computer-readable storage medium of claim 12, wherein generating the report information comprises:
generating the report information that includes packet-related statistics collected at the current-hop logical network element to indicate the connectivity issue.

14. The non-transitory computer-readable storage medium of claim 13, wherein identifying the logical network path comprises:
based on the logical network information specifying an active-standby mode associated with a particular logical network element, selecting an active instance of the particular logical network element for the logical network path.

15. A computer system, comprising:
a processor; and
a non-transitory computer-readable medium having stored thereon instructions that, when executed by the processor, cause the processor to:
receive a request to perform an offline connectivity check between a source endpoint and a destination endpoint;
obtain logical network information associated with a production environment in which multiple logical network elements are deployed;
based on the logical network information, identify a logical network path connecting the source endpoint and the destination endpoint, wherein the logical network path includes at least a subset of the multiple logical network elements;
based on the logical network information, perform an offline traversal of the logical network path outside of the production environment; and
in response to detecting a connectivity issue during the offline traversal, generate report information identifying the logical network path and the connectivity issue.

16. The computer system of claim 15, wherein the instructions for performing the offline traversal cause the processor to:
assess reachability of the destination endpoint from a current-hop logical network element located on the logical network path, wherein the logical network information includes layer-2 forwarding information or layer-3 forwarding information, or both.

17. The computer system of claim 16, wherein the instructions for performing the offline traversal cause the processor to:
in response to determination that the current-hop logical network element is a logical router port or a logical router, assess the reachability based on layer-3 forwarding information associated with the logical router port or the logical router.

18. The computer system of claim 16, wherein the instructions for performing the offline traversal cause the processor to:
in response to determination that the current-hop logical network element is a logical switch port or a logical switch, assess the reachability based on layer-2 forwarding information associated with the logical switch port or the logical switch.

19. The computer system of claim 15, wherein the instructions for performing the offline traversal cause the processor to:
assess reachability of the destination endpoint from a current-hop logical network element located on the logical network path, wherein the logical network information includes packet-related statistics.

20. The computer system of claim 19, wherein the instructions for generating the report information cause the processor to:
generate the report information that includes packet-related statistics collected at the current-hop logical network element to indicate the connectivity issue.

21. The computer system of claim 20, the instructions for identifying the logical network path cause the processor to:
based on the logical network information specifying an active-standby mode associated with a particular logical network element, select an active instance of the particular logical network element for the logical network path.
